(19) United States
(12) Patent Application Publication
(10) Pub. No.: US 2006/0006240 A1
(43) Pub. Date: Jan. 12, 2006

(54) Utility component identification systems

(75) Inventor: Earl R. Singleton, Oxford, GA (US)

Correspondence Address: WOMBLE CARLYLE SANDRIDGE & RICE, PLLC, P.O. BOX 7037, ATLANTA, GA, 30357-0037, US

(73) Assignee: Silt-Saver, Inc.

(21) Appl. No.: 11/167,730

(22) Filed: Jun. 27, 2005

Related U.S. Application Data
(60) Provisional application No. 60/585,997, filed on Jul. 7, 2004.

(51) Int. Cl. G06K 19/00; G09F 3/10

(52) U.S. Cl. 235/487; 439/488; 40/299.01

(57) ABSTRACT

Various devices and systems for identifying utility components are provided.

### CROSS-REFERENCE TO RELATED APPLICATION

This application claims the benefit of U.S. Provisional Application 60/585,997 filed Jul. 7, 2004, which is incorporated by reference herein in its entirety.

### BACKGROUND

Utility systems, such as for natural gas, drinking water, recycled water, and sewers, are distributed over large geographical areas and include large numbers of components that must be accessed for maintaining the systems. Locating these utility components often is a time-consuming and inefficient process because their location is not clearly marked. For example, utility system valves typically are buried underground and accessed through small openings covered with cast iron ground level covers. These cast iron covers typically are labeled to indicate the valves they cover and sometimes are painted with a color that is associated with that particular utility. For example, blue often is used for drinking water, purple is used for recycled water, and yellow often is used for natural gas. Not surprisingly, these covers frequently are obscured by vegetation, dirt and debris, thus making them difficult to locate when necessary.

Concrete markers are used sometimes to indicate the location of utility line valves. These markers typically are posts that are anchored in the ground adjacent the valve cover. Such markers also may be painted to identify the particular utility. However, these posts are difficult to transport and install due to their weight, and often tend to fade and crack and/or break over time, thereby limiting their usefulness.

### SUMMARY

Various aspects of identification devices and systems for utility components are provided herein. In one aspect, the present invention is directed to various embodiments of valve collars that are configured to be aligned over the access opening to a utility valve. In another aspect, the present invention is directed to various embodiments of valve markers that may be positioned proximate to and/or aligned with a valve access opening. In yet another aspect, the present invention is directed to various types or embodiments of utility cover identification systems that include a combination of a valve collar and a valve marker. In still another aspect, the present invention contemplates color-coding schemes that may be used identify the types and locations of utility system components. In a still further aspect, the present invention is directed to a method of locating and/or identifying a valve, for example, a utility valve. In yet another aspect, the present invention is directed to a system for obtaining and collecting data about a particular utility line.

### BRIEF DESCRIPTION OF THE DRAWINGS

FIG. 1 depicts a perspective view of an exemplary collar that may be used according to various aspects of the present invention;

FIGS. 2-9 depict various collars that may be used according to various aspects of the present invention, in schematic top plan view;

FIGS. 10-11 depict a perspective view of various exemplary markers that may be used according to various aspects of the present invention;

FIG. 12 depicts a perspective view of an exemplary utility component identification system including a valve collar and a valve marker, according to various aspects of the present invention.

### DETAILED DESCRIPTION

The various aspects of the present invention may be best understood by referring to the following figures. For purposes of simplicity, like numerals may be used to describe like features. However, it should be understood use of like numerals is not to be construed as an acknowledgement or admission that such features are equivalent in any manner.

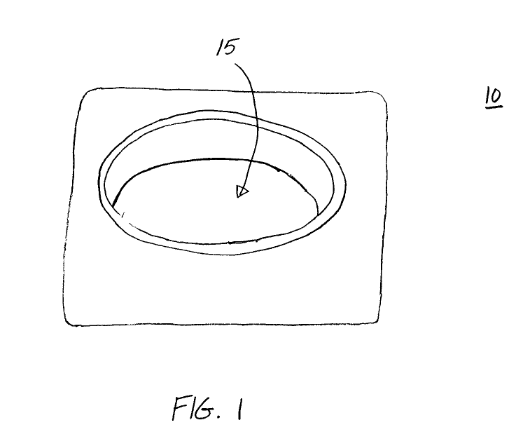

FIG. 1 depicts one exemplary embodiment of a collar 10 according to one aspect of the present invention. The collar 10 includes an aperture 15 designed to receive and fit about or be aligned around the access opening to a valve or access port of a utility line (not shown). In this example, the aperture 15 is shown as being generally cylindrical and centrally aligned within the collar 10. However, it will be understood that other aperture shapes are contemplated hereby. For example, the shape of the aperture may be similar to, the same as, or different from the shape of the access opening of the valve.

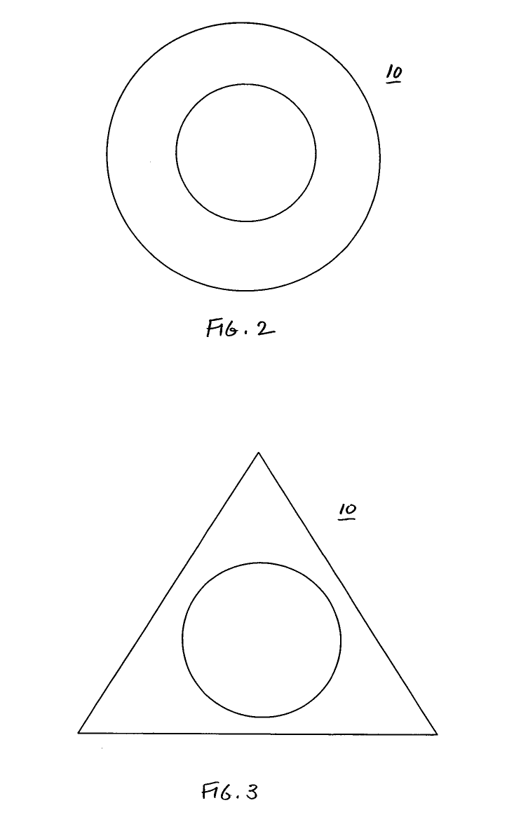

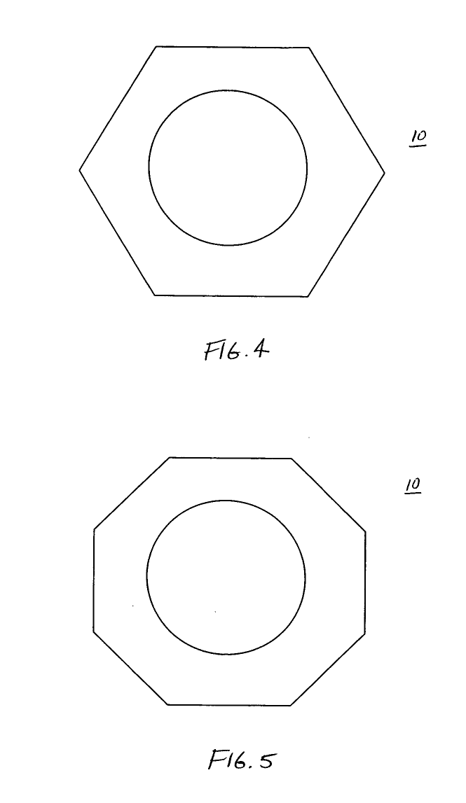

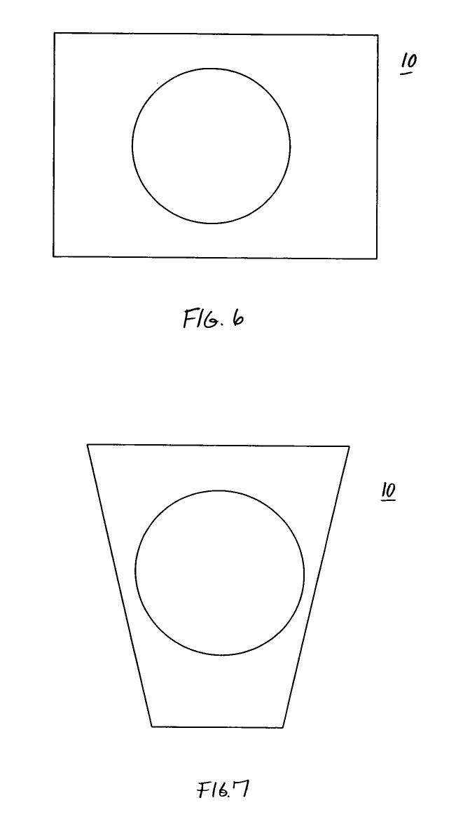

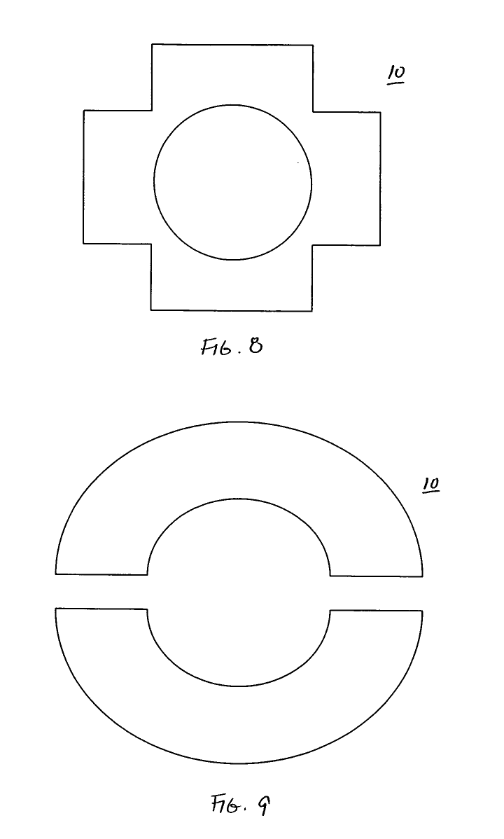

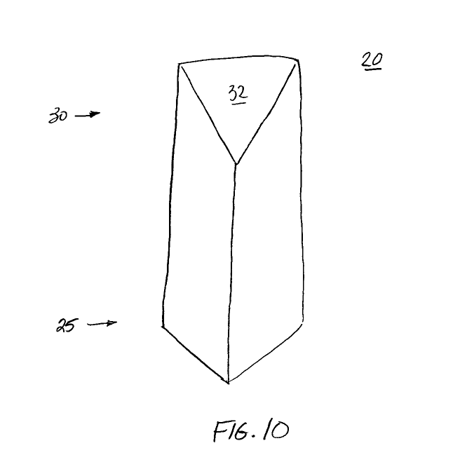

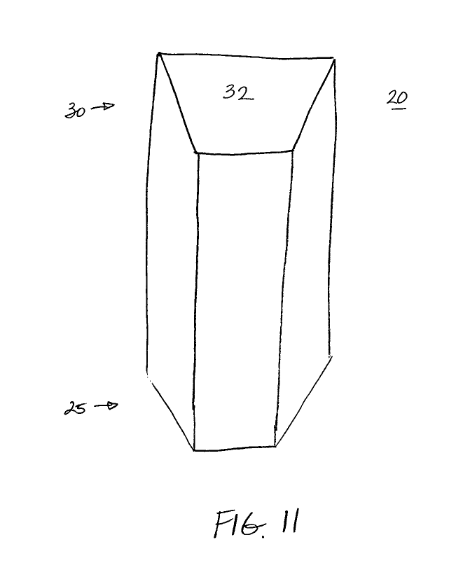

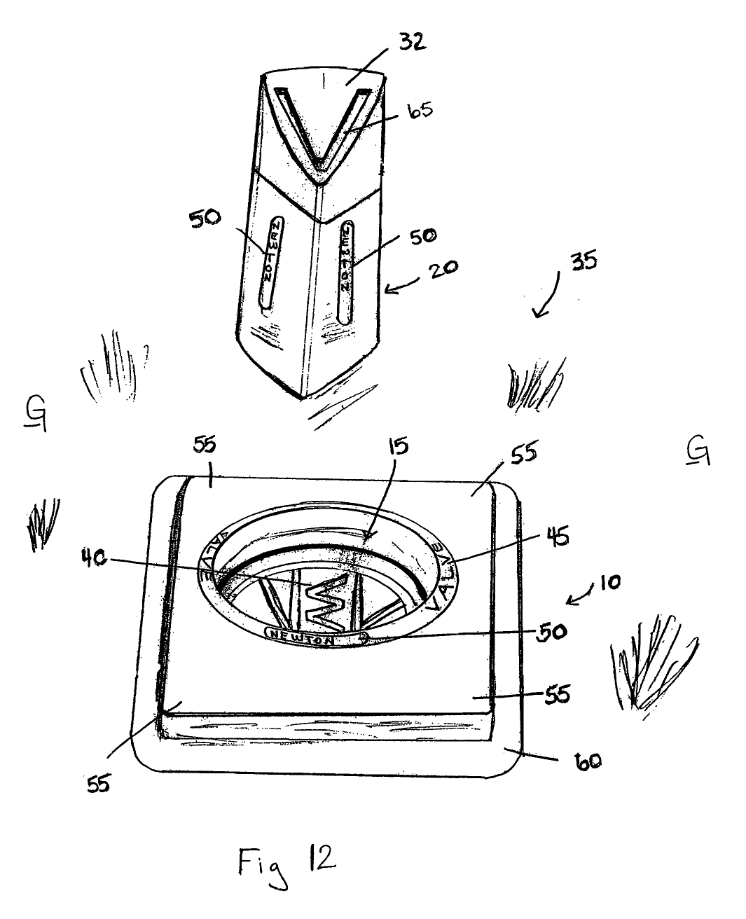

The collar shown in this example embodiment generally is substantially square or rectangular in shape. However, it will be understood that numerous other shapes and configurations are contemplated by the present invention. Examples of other shapes encompassed hereby include, but are not limited to, polygons, circles, ovals, cylinders, prisms, spheres, polyhedrons, and ellipsoids. Some such examples are depicted in FIGS. 2-9. The shape of the collar may be determined by the shape of the valve. If needed or desired, the collar shape also may serve as an identifying feature for a particular type of utility line. Thus, different collar shapes may be used for different types of utility lines or valves, for example, recycled water valves, potable water valves, and natural gas valves. In this manner, the shape of the collar may be used to differentiate between various types of utility lines and valves.

The collar may be made from any non-corrosive, impact resistant material. Examples of materials that may be suitable include, but are not limited to, polymeric materials, for example, high density polyethylene, polypropylene, polyvinyl chloride, or other polymeric material or any combination of materials, metals or metal alloys, for example, stainless steel or aluminum, as well as various composite or other durable, non-corrosive materials, or any combination thereof.

The collar may be formed from solid material such that there are substantially no voids in the interior thereof. Alternatively, the collar may include one or more voids on an interior thereof. Such voids optionally may be filled with a substance, for example, sand, to achieve a desired total weight.

If desired, the collar may be formed from a flexible, extensible, and/or elastomeric material to provide a tighter fit around the valve opening or to accommodate objects proximate the valve opening, for example, tree roots or plant matter. Likewise, the collar may be formed from a malleable or fixedly deformable material. Further, the collar may include one or more engaging members, such as a lock, leaf, leaf spring, clamp, or flange that bears against the valve opening to secure the collar in position.

The collar may have a unitary construction, as shown in FIGS. 2-8, or may have a multi-piece construction, as shown in FIG. 9. A multi-piece construction may be suitable where, for example, objects proximate the valve access opening impede the ability of the collar to be situated with the desired degree of stability. Any of the numerous collar configurations contemplated hereby may feature a unitary (or single-piece) construction or a multi-piece construction including two or more pieces. Where a multi-piece construction is used, the various segments of the collar may be provided with a ball detent, clips, hooks, stakes, snap locks, or other fastening or locking features for securing the segments to at least one other segment or to the ground.

The collar further may include one or more features that allow the collar and, therefore, the valve access opening to be detected readily from a desired distance. For example, the desired distance may be at least about 0.5 m. In another example, the desired distance may be at least about 1 m. In yet another example, the desired distance may be at least about 10 m. In still another example, the desired distance may be at least about 15 m. Other distances are contemplated hereby.

In one aspect, the collar includes indicium (or indicia) that allows the collar and, therefore, the valve access opening to be detected readily from the desired distance. The indicia may be printed on, engraved into, molded into, imprinted into, or otherwise applied to the collar. The indicia may provide information about the type of line, the county, town, state (collectively “geographic information”), or company associated with a particular utility line, any other information, or any combination thereof.

In another aspect, in addition or as an alternative to identifying indicia, one or more colors may be provided on the collar to identify the type of utility component with which the collar is used. For example, the collar can be colored blue to indicate a potable water valve. Either the entire collar or a portion thereof can be formed with the appropriate color. A plurality of collars of various colors that correspond to colors within a color coding system for identifying utilities in a specified area may be provided. For example, collars that are blue, purple, yellow, etc., corresponding to drinking water, recycled water, natural gas, and other utilities may be used. The color can be applied to the collar using any suitable painting or coating technique, or may be incorporated into the material from which the collar is constructed to provide uniformity to the appearance of the collar.

In yet another aspect, the collar includes one or more reflective portions. The reflective portion may be integral with the collar, may be affixed thereto, or may be a separate component that overlies the collar. Optionally, the reflective portion may provide information about the type of line, the county, town, state, or company associated with a particular utility line, any other information, or any combination thereof.

To use the collar, the collar may be seated on the ground or partially buried or otherwise anchored in place. At least a portion of the collar may extend above ground level when aligned over the access opening of a utility valve to facilitate identification and location of the valve. In use, the collar may be stabilized by a ground-lock effect when at least a portion of the collar is covered with grass, sod or dirt. Alternatively, anchors may be formed on the collar, attached thereto, or provided therewith for insertion into the ground to anchor the collar in place.

If desired, the collar may include any of various other features, such as microchips, radio frequency identification tags, bar codes, or other electronic identification components that facilitate efficient management of the utility system. Such devices may be used at the site of inspection, repair, or maintenance to retrieve information about the type of utility line, the maintenance history thereof, any problems associated therewith, and so forth. Thus for example, a utility employee may be provided with a transceiver-type reader device adapted to read the electronic identification component on site. The reader device may provide the resulting information on an information screen or display. Additionally, the resulting information also can be transmitted to an/or displayed in a vehicle or elsewhere. In the same manner, such a device may be used to input information at the time of inspection, repair, or maintenance to be transmitted to the utility company responsible for the line.

According to another aspect of the present invention, a valve marker is provided. An example of a valve marker 20 is depicted in FIG. 10. The marker may have any suitable shape, dimensions, and features that allow the marker to be viewed and identified from a desired distance. For example, the desired distance may be at least about 0.5 m. In another example, the desired distance may be at least about 1 m. In yet another example, the desired distance may be at least about 10 m. In still another example, the desired distance may be at least about 15 m. Other distances are contemplated hereby.

The various markers contemplated hereby may have any dimensions as needed or desired for a particular application. For example, if the marker is placed in an area including tall grasses or brush, it might be desirable to select a longer marker. In contrast, if the marker is placed in a highly visible or conspicuous area, it might be desirable to select a shorter marker. As an example, the marker may have a length of less than about 12 inches. As another example, the marker may have a length of from about 12 to about 36 inches. As yet another example, the marker may have a length of from about 36 inches to about 48 inches.

If needed or desired to facilitate the secure anchoring of the marker in position, the lower portion or end of the marker (closer to the ground) may be larger in dimension than the upper portion or end. Alternatively, the lower portion or end of the marker may be smaller in dimension than the upper portion or end. Alternatively still, the lower portion or end of the marker (closer to the ground) may be substantially equal in dimension to the upper portion or end of the marker.

As shown in FIG. 10, the marker 20 can be generally triangular or pyramidal in shape and can vary in its dimensions along its length. In the example depicted in FIG. 10, the lower end 25 of the marker 20 has dimensions greater than that of the upper end 30. The top portion or face 32 of the marker can be angled downwardly in a beveled or wedge-shaped configuration to facilitate viewing and identification. Other configurations are contemplated hereby. Thus, for example, the marker may be shaped as a rectangular pyramid (FIG. 11), cube, or any other shape.

In use, the marker is at least partially inserted into the ground proximate a utility component, such as a valve. The top portion or face may be positioned to face the valve to facilitate the location of the utility component.

The marker may be made from any non-corrosive, durable, impact resistant material. Examples of materials that may be suitable include, but are not limited to, polymeric materials, for example, high density polyethylene, polypropylene, polyvinyl chloride, or other polymeric material or any combination of materials, metals or metal alloys, for example, stainless steel or aluminum, various composite materials, or any combination thereof.

The marker may be formed from solid material such that there are substantially no voids in the interior thereof. Alternatively, the marker may include one or more voids on an interior thereof. Such voids optionally may be filled with a substance, for example, sand, to achieve a desired total weight.

In one aspect, the marker may include an alphanumeric letter or other indicium (or indicia). The indicium may identify the type of utility component, the county, town, state (collectively “geographic information”), or company associated with a particular utility line, any other information, or any combination thereof. The indicium may be printed on, engraved into, molded into, imprinted into, or otherwise applied to the marker.

In another aspect, in addition or as an alternative to the marker having identifying indicia applied to or formed therein, one or more colors may be provided on the marker to identify the type of utility component with which the marker is used. For example, the marker can be colored blue to indicate a potable water valve. Either the entire marker or a portion thereof can be formed with the appropriate color. A plurality of markers having various colors that correspond to colors within a color coding system may be provided for identifying utilities in a specified area. For example, blue, purple, yellow, etc. markers, corresponding to drinking water, recycled water, natural gas, and other utilities may be provided. The color can be applied to the marker using any suitable painting or coating technique, or may be incorporated into the material from which the marker is constructed to impart a permanent color to the marker. Alternatively, colored ribbons, tapes, strips, bands, or other materials may be applied or affixed to the marker.

If needed or desired, the upper section of the marker may be a high visibility color, such as white, yellow, or orange, and may include reflective materials or coatings to increase visibility. These features can be incorporated into the marker during manufacturing or after the marker is formed.

In yet another aspect, the marker includes one or more reflective portions. The reflective portion may be integral with the marker, may be affixed thereto, or may be a separate component that overlies the marker. Optionally, the reflective portion may provide information about the type of line, the county, town, state, or company associated with a particular utility line, any other information, or any combination thereof.

If desired, the marker also may include any of various other features, such as microchips, radio frequency identification tags, bar codes, or other electronic identification components that facilitate efficient management of the utility system. Such devices may be used at the site of inspection, repair, or maintenance to retrieve information about the type of utility line, the maintenance history thereof, any problems associated therewith, and so forth. Thus for example, a utility employee may be provided with a transceiver-type reader device adapted to read the electronic identification component on site. The reader device may provide the resulting information on an information screen or display. Additionally, the resulting information also can be transmitted to an/or displayed in a vehicle or elsewhere. In the same manner, such a device may be used to input information at the time of inspection, repair, or maintenance to be transmitted to the utility company responsible for the line. According to yet another aspect of the present invention, a utility component identification system is provided. Although a particular system is described herein, it will be understood that the system may include combination of the various features described herein in connection with individual components or contemplated hereby.

In the example illustrated in FIG. 12, the system 35 includes a valve collar 10 and a valve marker 20. The collar 10 includes an aperture 15 designed to receive and fit about or be aligned around the access opening to a valve 40 of a utility line. In the exemplary system 35 depicted in FIG. 12, the collar 10 includes a neck 45 extending around the aperture 15. The neck 45 includes indicia 50 thereon indicating the type of utility and/or utility component the collar 10 is identifying.

Shoulders 55 define a border spaced outwardly from the neck 45. The shoulders 55 may have various configurations, such as the square or rectangular designs shown in FIG. 12, though other shapes or configurations also can be used. A skirt 60 extends outwardly from the border of the collar 10. The skirt 60 may mirror substantially the configuration of the shoulders 55, or may be configured in other alternative shapes.

An accompanying marker 20 is provided with the system 35. The exemplary marker 20 is triangular pyramidal in shape and includes a beveled face 32. The marker 20 includes a reflective material 65 in a V-shape on the face 32. Indicia 50 is provided on the marker 20. If desired, the face or any other portion of the marker 20 may be colored, or may include any other visual identification feature, as desired.

The collar 10 generally is positioned on the ground G around or adjacent the valve access opening 40. The marker 20 similarly can be positioned proximate or adjacent the collar 10 with the face 32 positioned in a direction toward the valve 40.

If desired, the system also may include any of various other features, such as microchips, radio frequency identification tags, bar codes, or other electronic identification components that facilitate efficient management of the utility system. As stated previously, such devices may be used at the site of inspection, repair, or maintenance to retrieve information about the type of utility line, the maintenance history thereof, any problems associated therewith, and so forth. Such devices also may be used to input information at the time of inspection, repair, or maintenance to be transmitted to the utility company responsible for the line.

It is to be understood that the above examples of the utility component identification systems are provided for illustration and are not to be construed to limit the scope of the disclosure. The disclosure encompasses modifications and alterations made by those of ordinary skill in the art to the disclosed examples.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention. The detailed description set forth herein is not intended nor is to be construed to limit the present invention or otherwise to exclude any such other embodiments, adaptations, variations, modifications, and equivalent arrangements of the present invention.

What is claimed is:

1. A utility valve identification device comprising:
a collar having an aperture dimensioned to receive a valve opening, the collar including at least one feature identifying a utility type.

2. The utility valve identification device of claim 1, wherein the feature identifying the utility type comprises a color.

3. The utility valve identification device of claim 2, wherein the color corresponds to a particular utility type established by a color coding system.

4. The utility valve identification device of claim 1, further comprising at least one indicium providing geographic information, ownership information, or a combination thereof.

5. The utility valve identification device of claim 1, further comprising a reflective material.

6. The utility valve identification device of claim 1, having a unitary construction.

7. The utility valve identification device of claim 1, having a multi-piece construction.

8. A utility valve identification device comprising:
a marker adapted to be mountable in a substantially upright position proximate a valve opening, the marker including at least one feature identifying a type of utility.

9. The utility valve identification device of claim 8, the marker having a triangular pyramidal shape.

10. The utility valve identification device of claim 8, the marker including a flattened face.

11. The utility valve identification device of claim 8, the marker having a first end that is smaller in dimension than a second end.

12. The utility valve identification device of claim 8, the marker having a first end that is substantially equal in dimension to a second end.

13. The utility valve identification device of claim 8, wherein the feature identifying the utility type comprises a color.

14. The utility valve identification device of claim 13, wherein the color corresponds to a particular utility type established by a color coding system.

15. The utility valve identification device of claim 8, further comprising at least one indicium providing geographic information, ownership information, or a combination thereof.

16. The utility valve identification device of claim 8, further comprising a reflective material.

17. A system for marking and identifying a utility valve comprising, in combination:
a collar having an aperture adapted to receive a valve opening; and
a marker positioned proximate the collar;
wherein at least one of the collar and marker includes at least one feature identifying a type of utility.

18. The system of claim 17, wherein the marker has a triangular pyramidal shape and includes a flattened face on an upper portion thereof.

19. The system of claim 17, wherein at least one of the collar and marker further includes a reflective material, an indicium comprising providing geographic information, an indicium providing ownership information, or any combination thereof.

20. A system for obtaining and collecting data about a utility line comprising:
(a) at least one of:
(i) a collar having an aperture that receives a valve opening; and
(ii) a marker positioned proximate a valve opening,
wherein at least one of the collar and marker includes a feature identifying a type of utility line; and
(b) an electronic identification component for inputting and/or retrieving information about the utility line.

21. The system of claim 20, further comprising a portable electronic device adapted to communicate electronically with the electronic identification component.

22. The system of claim 20, wherein the electronic identification component comprises a microchip, radio frequency identification tag, or a bar code.
